(19) United States
(12) Patent Application Publication
(10) Pub. No.: US 2002/0016721 A1
(43) Pub. Date: Feb. 7, 2002

(54) System and method for automating record keeping

(76) Inventors: Steven Mason, Nashville, TN (US); Thomas J. Abruzzo, Nashville, TN (US); Troy Abruzzo, Nashville, TN (US)

Correspondence Address: BANNER & WITCOFF, 1001 G STREET N W, SUITE 1100, WASHINGTON, DC, 20001, US

(21) Appl. No.: 09/873,394

(22) Filed: Jun. 5, 2001

Related U.S. Application Data
(60) Provisional application No. 60/208,908, filed on Jun. 5, 2000.

(51) Int. Cl. G06F 17/60; G06F 17/30; G06F 15/16

(52) U.S. Cl. 705/3; 707/104.1; 707/10; 707/507

(57) ABSTRACT

A system and method for automating record keeping is disclosed. A client transmits patient information to a remote database via the Internet. The database stores the patient information and provides it to other clients as authorized. In some embodiments, the client inputs patient information in forms that have been pre-populated with known patient information or have only fields that need patient information. In other embodiments, a user completes modules for each patient. One set of modules may be used for all patients or the specific modules used for each patient may be customized. In further embodiments, the invention may be used in a behavioral healthcare services environment.

### RELATED APPLICATION INFORMATION

This application claims priority to U.S. Ser. No. 60/208,908, entitled “System and Method for Automated Record Keeping”, filed Jun. 5, 2000, whose contents are expressly incorporated herein by reference.

### BACKGROUND

1. Technical Field

The invention generally relates to record keeping. More particularly, the system relates to streamlining value-added clinical and administrative tasks in the health-care industry.

2. Related Art

The healthcare delivery system has changed over the last five years. There has been a corresponding increase in the need for innovative technological solutions to support these changes. While the need for more advanced technological applications exists throughout the entire continuum of healthcare services, the behavioral healthcare sector is significantly behind the medical/surgical sector in this regard. The behavioral healthcare field continues to be plagued by fragmentation among providers and payors with the scope, availability, quality, and funding of services varying significantly from state to state. Tremendous inefficiencies exist throughout the behavioral healthcare service chain as organizations struggle to survive in an industry characterized by a lack of information flow between participants, poor capital resources, continued escalation in provider costs, increases in outcomes-based reimbursement and provider accountability, and dramatic decreases in funding for traditional facility-based treatment. Consolidations and mergers among mental health providers continue to occur as providers look for alternative mechanisms to cut costs and increase their client base in order to generate greater operating revenue to sustain their operations and their status as an essential provider within their market. Recent studies (Wit Capital, e-Health 2000, Jan. 31, 2000) estimate that between $0.25 to $0.40 of every healthcare dollar is spent on excessive administrative costs, the performance of redundant tests and the delivery of unnecessary care. Therefore, a need exists reduce excessive and redundant administrative and clinical tasks while improving the cost and quality of care.

While attention has been directed to heath-care sector, little attention has been paid to the behavioral healthcare arena. A recent research report prepared by SunTrust Equitable Securities in May 1999 analyzed 59 “digital health care companies” that represented the most evolving and attractive companies in the market. Of the 59 companies reviewed, none of them provided services in the behavioral health care sector of the industry. While this is not a definitive list of all digital health care companies, it does suggest that there is a lack of noteworthy e-healthcare companies currently focusing on and providing technology based business to business (B2B) and business to consumer (B2C) services to behavioral healthcare constituents—consumers, employers, providers and payors. While a number of companies have attempted to enter into the health care industry, the behavioral health care sector lacks adequate attention. At least one impediment is the high cost of administrative expenses in maintaining a practice. For example, some of the expenses that arise in the behavioral health care industry include the significant amount of documentation that needs to be generated as part of the record keeping process. Persons needing behavioral heath care generally require extensive diagnosis prior to receiving treatment. Next, while being treated, the patients also require monitoring, requiring documentation as well. This level documentation continues to serve as an impediment to entry for businesses into the behavioral health care field. Further, for those companies in the field, their profit margins are kept low because of the level of documentation needed. In some cases, this means that the cost of the inefficiencies is passed onto the healthcare consumer.

Some have attempted to use computer systems to increase automation of record keeping. Rapid application development (RAD) tools (for example, Cold Fusion by Allaire, Inc.) have been used to support tailored deployment of database tracking applications. Despite the ability to quickly generate an application, these tools require the use of a separate set of local servers to handle requests from clients and to generate the pages to be used by clients. If a company was to attempt to deploy numerous RAD systems, each system would have to be maintained as each system has its own set of servers. For smaller clients, personalized solutions are thus not available as the smaller clients cannot afford the staffing costs of skilled server administrators. Further, RAD solutions have generally resulted in a requirement of needing software-heavy clients due to the complexities of information sent to clients. This high complexity has created bandwidth problems for small clients who have limited bandwidth available.

Accordingly, a system is needed that minimizes administrative expenses while providing resources to assist health care providers to provide services in an efficient manner.

### SUMMARY

The present invention provides a system and method for obtaining information from health care users, health care providers and vendors to the health care industry. Also, the system and method use this information to coordinate record keeping tasks, referral submissions, and insurance payments.

In some aspects of the present invention, systems and methods provide enhanced coordination, measurement, and delivery of services to clients of health care institutions. In other aspects of the present invention, the systems and methods include a clinical and enterprise management environment that serves as a platform that meets the immediate needs of client organizations and also provides a framework to permit the expansion of the their systems for future growth. Finally, the system and method include valued-added clinical and administrative applications and enhancements to existing applications in order to continuously meet the changing needs of the behavioral healthcare industry.

These and other novel advantages, details, embodiments, features and objects of the present invention will be apparent to those skilled in the art from following the detailed description of the invention, the attached claims and accompanying drawings, listed herein, which are useful in explaining the invention.

### BRIEF DESCRIPTION OF THE DRAWINGS

FIG. 1 shows an exemplary functional network architecture in accordance with embodiments of the present invention.

FIG. 2 shows an exemplary modular form generation system in accordance with embodiments of the present invention.

FIG. 3 shows an exemplary method for record keeping from a web server in accordance with embodiments of the present invention.

FIG. 4 shows an exemplary method for record keeping from a web-based client in accordance with embodiments of the present invention.

FIG. 5 shows an alternative method for record keeping from a web server in accordance with embodiments of the present invention.

FIG. 6 shows a functional module processing system in accordance with embodiments of the present invention.

### DETAILED DESCRIPTION

The present invention relates to a system and method for coordinating all administrative aspects of a behavioral health care provider.

In one embodiment, the system relates to a full suite of ASP-based, Internet applications that allows mental health clinicians and administrators to manage all aspects of their clinical enterprise on-line using an Internet browser.

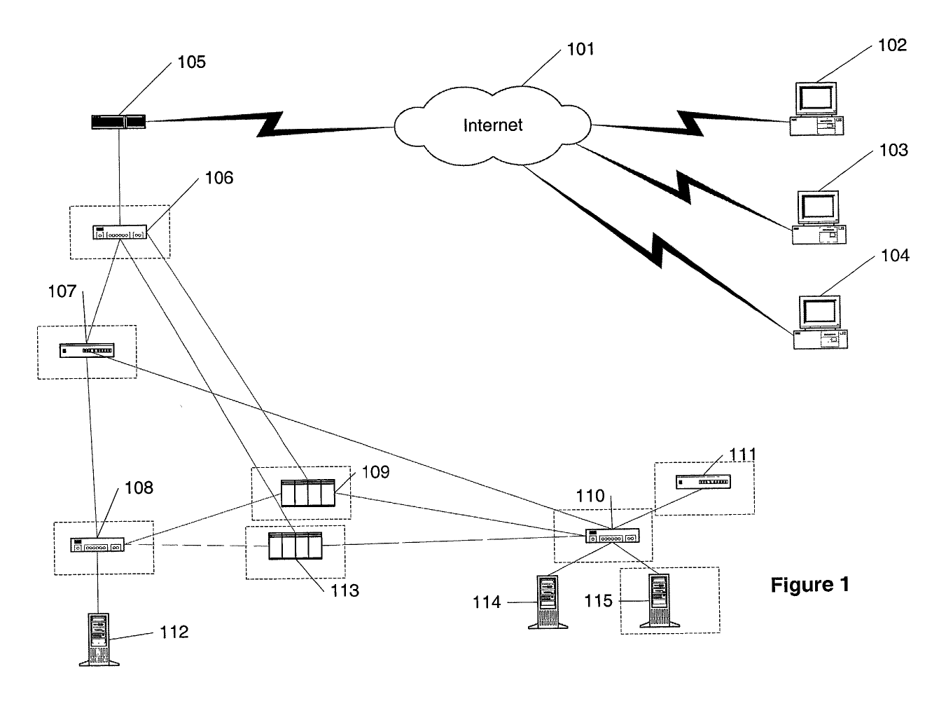

FIG. 1 shows a functional network diagram. Internet 101 connects clients 102-104 to a server-side automated record keeping system. Router 105 passes information from the Internet 101 to web server 114, which passes information to database server 112. Additional optional elements are shown in dotted boxes. These elements may be added to enhance the reliability of the system. For example, switches 106, 108, and 110 may be added. Also, firewalls 109 and 113 may be added as well. An additional web server or servers 115 may be added to provide more data handling capability. Load balancers 107 and 111 may be added to balance the load on the firewalls 109 and 113 and on the web servers 114 and 115, respectively.

The database server 112 used by the system and method allows fast, secure, reliable and affordable access for providers, payors and consumers from any location using a browser, user ID and a password. The browser may be a low-grade, non-Java enabled browser running on a thin client. In this regard, the database server 112 may transmit text or simple HTML pages to the clients 102-104 for display. The economic and operational benefits of the clinical enterprise management applications are significant compared to the traditional client/server-based software applications that are commonly installed and used by behavioral healthcare providers.

In one embodiment, the web server 114 may run Oracle 9 IAS on a Windows 2000 operating system over Dell hardware. The database server may be Oracle 8i over AIX running on IBM RS6000 hardware. Other software and hardware as known in the art may be used. The system as projected to the client relieves the client of significant processing burdens. In this regard, the clients may only be capable of running a low level browser. The database server may have predefined forms and uses PL-SQL procedures to obtain the forms.

In some embodiments, the database server 112 generates HTML web pages that are passed to the client. The client, when using the generated HTML pages, returns information to the database server 112. The HTML pages may include predefined PL-SQL procedures embedded in them so that information returned to the database server may executed in the database server itself, rather than in an intermediate server which then passes procedures to the database server. This provides the benefit of allowing screens to load faster than heavily loaded Java-based screens and is easier to change and update—resulting in a more efficient and seamless user experience. This also minimizes the processing required by the web server 114.

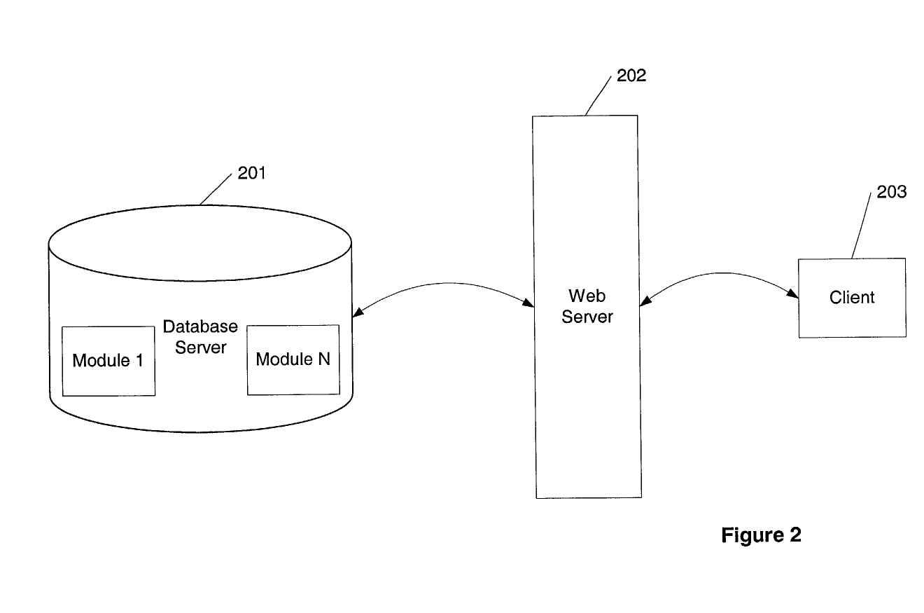

FIG. 2 shows database server 201 with modules stored within it (Modules 1 . . . N). The database server 201 communicates through web server 202 to client 203. It is appreciated that other clients exist but are not shown in this figure for simplicity. The link between the web server 202 and the client 203 may include the Internet. By providing a common database server 201 and web server 202, many clients may use the database without having to purchase significant client side processing systems. Further, maintenance of the database server 201 and the web server 202 may be handled from a single location, rather than having to perform this maintenance at every client location (as exists in situations involving significant proprietary client/server systems).

The modules 1-N may be referred to as sets of patient information a client completes. The modules may be broken into sub-modules. The results of completing the modules are stored in the database server and reused for providing information regarding patients to the client supplying the information as well as other clients.

In some embodiments, the applications are delivered over the Internet using a web browser, this eliminates the costs of purchasing, installing and maintaining expensive hardware and software. Additionally, because the system uses a secure procedure for transmitting confidential information over the Internet, users can use their browser and their Internet service provider rather than dialing into a secure Virtual Private Network (VPN). For the price of an Internet connection and a monthly user license fee, clients of all sizes, geographic configuration and resource availability may have real-time access to completely secure end-to-end enterprise management applications, secure company intranet, employee e-mail and a web site.

In one embodiment, the system may be embodied in a portal, which enables behavioral healthcare providers and payors to improve the efficiency of day-to-day administrative and clinical tasks of their employees. The system allows users to successfully manage all aspects of the care chain from referral to discharge to outcomes measurement, insurance verification, service cost analysis, human resources, billing, contract compliance and disease management.

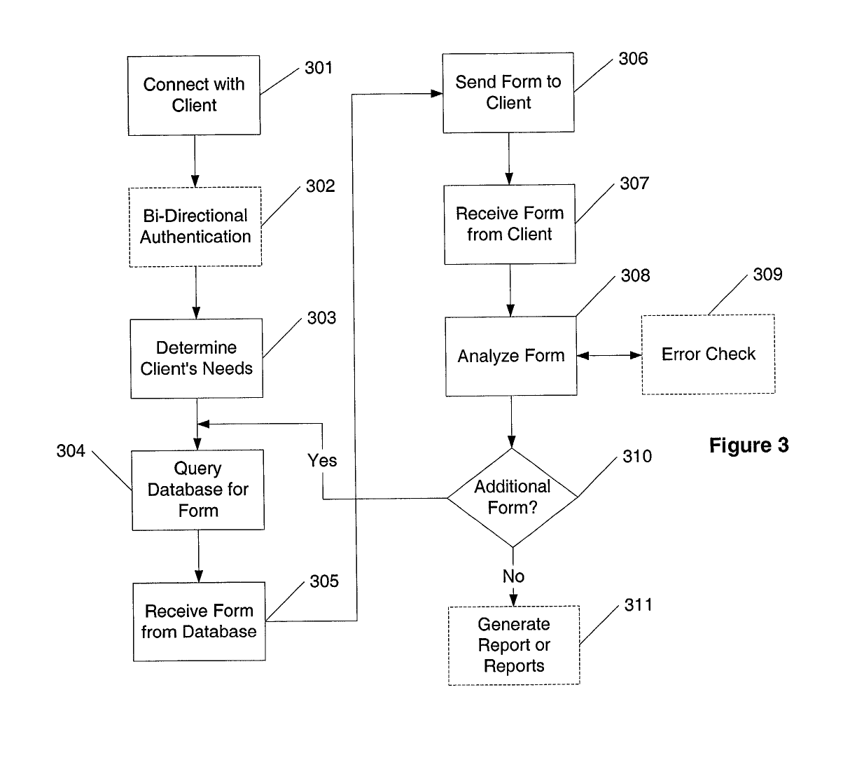

FIG. 3 shows a web server transmitting modules in the form of forms to a client. In step 301 a connection is established with the client. In step 302, bi-directional authentication may be achieved. Step 302 is optional as shown by the dotted box surrounding the step. In step 303, the web server determines the client's needs (possibly by receiving a request from the client for information). In step 304, the web server queries the database for a form satisfying the client's needs. In step 305, the web server receives the form from the database. In step 306, the web server sends the form to the client. In step 307, the system receives the completed form from the client. In step 308, the web server analyzes the form. The analysis may include error checking (optional step 309) and well as other checking procedures. Other procedures may include determining if an additional form is needed (in step 310). If yes, the form is retrieved and sent to the client. If not, the web server may wait until it receives other inputs from the client. In some embodiments, the client or other clients may request a report or reports be generated (step 311) to review or forward results to others.

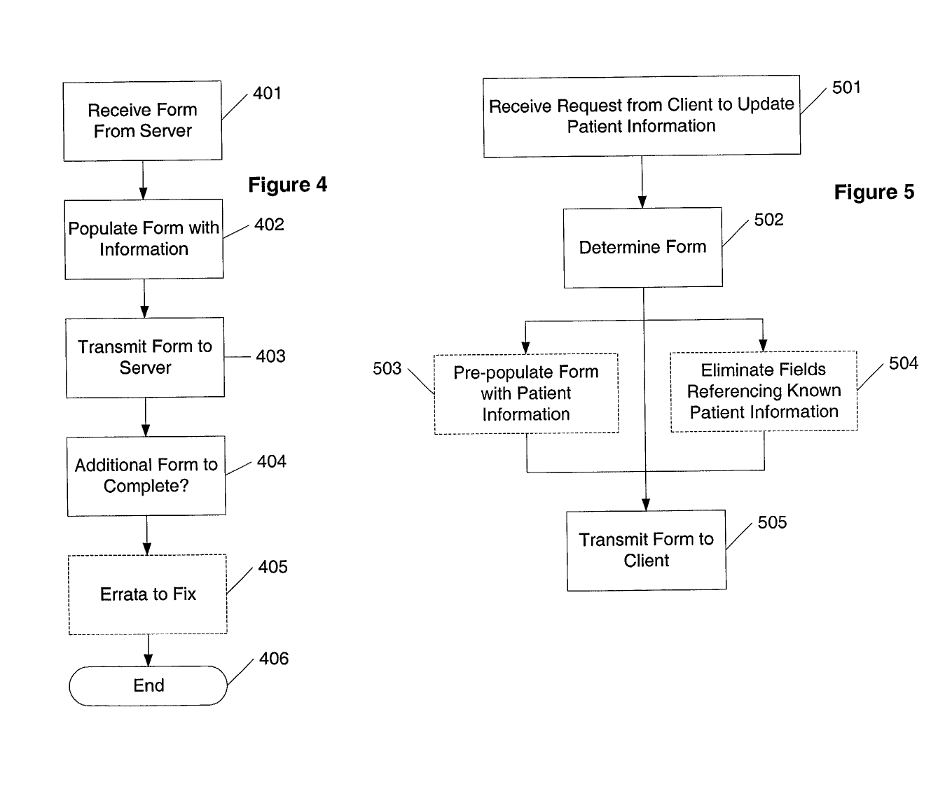

FIG. 4 shows a record keeping method from the perspective of the client. In step 401, the client receives a form from a web server. In step 402, the client inputs patient information into the form. In step 403, the client transmits the form (or at least the populated patient information) to the web server where additional processing may occur as set forth in FIG. 3 (for example, the web server may determine that an additional form needs to be completed and thus forwards the form to the client). In step 404, the client determines that an additional form has been received and completes it. In optional step 405, the client determines whether error information has been reported to it that it needs to fix. If so, it fixes any errors and forwards the results to the web server. Finally, the form processing is completed in step 406.

It is appreciated that the steps of FIGS. 3-5 may be rearranged without departing from the scope of the invention. For example, in FIG. 4, the error checking updates may come as soon as a form is uploaded. Alternatively, the web server may wait until all forms have been completed. If the system waits until all forms have been completed, then the web server may have the errors corrected by receiving corrected information from the client in another form without having to alert the client of the error.

FIG. 5 shows an alternative embodiment in which the web server performs additional steps to modify the forms transmitted to the client. In step 501, the web server receives a request from the client to update patent information. In step 502, the web server determines which form should be retrieved from the database server. In one embodiment, the form is sent directly to the client (step 505). In another embodiment, in step 503, the web server determines that some of the information in the form already exists and populates the fonn with this information so the user does not have to populate these aspects of the form. In a further embodiment, the web server eliminates fields that already have been populated (here, the database server already having information requested in the form) in step 504. In yet another embodiment, the permission level for the client may not permit the client to see all the fields available in the form so these fields may be omitted. An example is when a receptionist may only see a person's name or identification number while being prevented from seeing the person's medical history. This helps ensure that confidentiality is maintained for patients.

The invention includes a variety of applications and services. These include supporting a client website, which serves as a “front-end” into a server-side database, client e-mail, a company Intranet and other web hosting functions. Also, the system supports password-protected Internet access through a browser (Explorer, Netscape, America Online) to clinical and enterprise management applications. The combination of Internet access and the clinical and enterprise management applications may include the following features.

1. Password protected access to provide for appropriate confidentiality

2. Access from any internet connection by any user with a verified password

3. A clinical management system which provides for:

a. Referral processing

b. Initial assessment

c. Admission

d. Initial case budgeting and cost analysis

e. Master demographics

f. Appointment scheduling and case assignment

g. Treatment planning

h. Progress notes and other critical clinical record documentation (Electronic clinical records meet JCAHO, HCFA and CARF accreditation standards)

4. Entry of service information from contracted providers

5. Coordination of service providers

6. Interim comparisons of actual to budgeted cost

7. Resource allocations, including tracking payments in kind or other similar contributions

8. Grant compliance reporting

9. Outcome measurements

10. Discharge planning and coordination

11. Client satisfaction telephone monitoring system

12. An enterprise management system which provides for:

a. On-line documents and forms, including policies and procedures

b. Aggregate information on children and their services

c. Human resources management

d. Credentialing and training tracking system

e. Encounter and service data for billing

f. Real-time reports to monitor key management information

g. User defined password control

13. Help desk and support services

14. System documentation and user manuals

15. Further development of the system as agreed between the parties

16. Maintenance of the system on an on-going basis

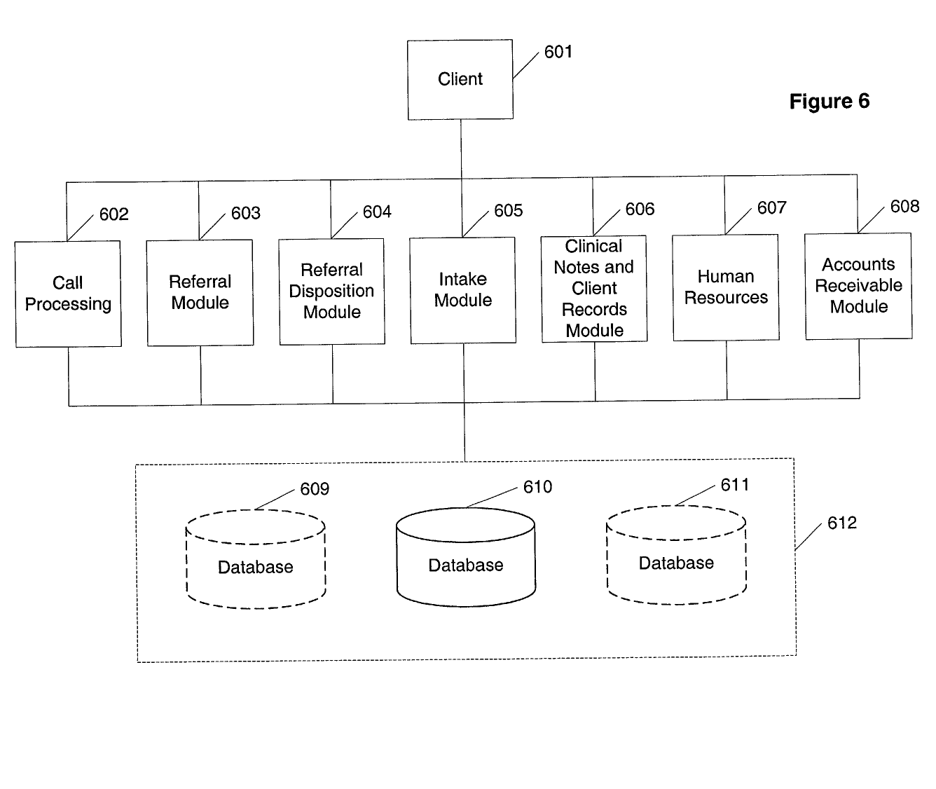

FIG. 6 shows a function diagram of modules being transmitted between a database and a client. Here, client 601 requests and receives information modules 602-608 from database 610. The database 610 may be a farm 612 of databases (609, 610, and 611), all redundant or each having a different set of information stored therein. The information from one completed module may be reused to complete other modules. This ability streamlines the data entry provisions that may be required for some health maintenance organizations. The modules may be cross linked to provide information in accordance with accreditation standards including JCAHO, CARF, COA, NCQA, and HCFA. For example, the completion of one module may have enough information in the module to satisfy at least one accreditation standard. In some embodiments, the modules may be provided to a client in a form that the completion of each module satisfies all criteria of each accreditation.

Various applications are provided below. The various applications may include modules as discussed above.

For example, three applications are listed below.

1. Clinical Management Applications—provide end-to-end clinical and enterprise management system that allows the user to perform all major treatment functions beginning with the initial referral through discharge to post treatment follow up. The management applications include:

a. Referral processing and tracking

b. Client assessment and screening

c. Intake and admissions processing

d. Utilization management

e. Treatment planning and review

f. Internet Based Electronic Record (IBER) complies with CARF, HCFA and JCAHO standards

g. Electronic auditing and compliance review of IBER

h. Telephonic behavior and disease monitoring system (treatment and post treatment)

i. Discharge planning

j. Medication tracking system

k. Individual and aggregate clinical outcomes measurement

The clinical management applications improve the efficiency and management of client records within a mental health center or mental health provider setting. Through organized input screens, the applications and functions reduce the most common procedural and documentation mistakes and while improving the flow of clinical information for clinicians to use to more effectively manage the provision of care.

2. Enterprise Management Applications. The system also offers a fully integrated clinical enterprise management system that allows administrative and clinical personnel to perform all the activities necessary to operate and manage an effective clinical enterprise or practice.

The Enterprise Management Applications may include the following functionality:

a. Marketing and referral development management

b. Human resource management (includes employee training data)

c. Credential verification and tracking

d. Fiscal management

e. Accounts receivable billing system

f. Online insurance verification

g. Funding authorization tracking and countdown alerts

h. Contract compliance management

i. Client activity tracking system (tracks clinical and non-clinical services provided)

j. Master client index of all vital financial and clinical information

k. Complete population management ability using real-time management reports (reports can be customized by the user to capture any combination of data elements related to clients, clinicians, referral and funding sources and more)

l. Program quality improvement and program performance measurement reports

m. JCAHO accreditation and compliance management

n. ORYX performance measurement and reporting

o. Network implementation and management

p. Client web-site design, intranet hosting and client e-mail

The enterprise management system simplifies and improves the efficiency of all of the major activities performed by a provider. Remote entry and access of information allows clinicians, managers and third party contractors to obtain critical data, clinical records and reports from any location in the country using a password and web browser.

3. School Violence Assessment System. The system identifies school students who demonstrate key high risks behaviors that put them at risk for possibly committing an act of violence against their classmates, teachers or other individuals. School systems around the country may be able to administer this instrument to their students and receive a confidential report identifying the potential areas of concern and risk. The School Violence Assessment instrument is currently under development by a joint team of experts from Vanderbilt University and UCLA. The screening tool is contemplated to be available online or using a computer for downloading and printing the form. The form may be later scanned in for computer processing if the results.

Business Methods

There are six primary revenue streams that are captured as a part of the use of the system.

a. Individual usage fees billed on a per user per month basis (recurring-5 year contract)

b. Annual maintenance and user support fees billed as a percentage of the total annual cost of the user fees (recurring-25% of total usage fees)

c. Training and consulting fees billed on a per trainer/consultant per day basis

d. Customized application development billed on a hourly basis

e. School Violence Assessment fees billed on a fee for per use basis

f. Advertising revenue captured from direct marketing on site supported by system and method

Dynamic Interactive Error Checking:

Uses indicators and parameters to check for data entry errors on a web-based entry form. If there are errors in the data entry, then the errors are explained, including suggestions and examples for fixing the errors. Only entry fields that are affected by the invalid data are re-displayed for changing, eliminating the need to display all of the other fields and consequently download and display unneeded information. The error checking procedure re-calls itself until the user has entered the data in the correct format. When the user has entered everything correctly, the data checker lets them know and gives them options of what they can do next.

Description of user to database interaction for displaying a form or information:

1. The user types in or goes to a web address.

2. The web server receives the address and sends a request to the database server to run a corresponding procedure from the given web address.

3. The database server executes the procedure, which outputs the code for a web page, and sends the web page to the web server.

4. The web server sends the web page to the user.

Description of user to database interaction for posting data to the database:

1. The user enters all applicable information into a web-entry form and clicks the Submit button.

2. The web server receives the information and sends it to the database server for data checking.

3. The database server runs a procedure that checks the data, and either:

a. Accepts the data and then:

i. Generates a web page showing successful insert/update of data.

ii. Sends that page to the web server.

iii. Web server sends that page to the user.

b. Does not accept the data and then:

i. Generates a web page (form showing errors and fields that are affected).

ii. Sends that page to the web server.

iii. The Web server sends that page to the user.

iv. Returns to step 1 until user gets the data entered correctly.

In the error checking system described above, if there is an error on a form, the web server may eliminate the fields that were populated correctly and only return the field that was not populated correctly. In this regard, the amount of information provided to the client is minimized to prevent other errors from being made in other fields. Alternatively, the web server may lock the other fields so that modification of correct fields may be prevented.

The following provides exemplary modules. The modules are for explanation purposes only. More or less information may be included in each based on client needs or desires.

Module 1: Call Processing:

1) Select:

“Information only”:

a) Name of caller:

b) Address of caller

c) Phone number of caller

d) Reason for call:

1. List box of options

2. Other

e) Action taken

1. List box of options

2. Other

f) Name of person providing information

g) Name of person sending information

h) Information request report: list of individuals, information requested and date information request made, name of sender

“Referral”

“if a referral, then go to Module 2”

Module 2: Referral

Sub Module 2.1: Referral Information

1) Date of referral

2) Name of referral source (individual/agency name)

3) If not on referral source list, add referral source address

4) Referral phone number

5) Fax number

6) Referral source type (list box)

7) Name of child being referred (first, last)

8) Alias/Nickname

9) Date of birth

10) SS#

11) Client's current address

Street, Apt#

City

County

State

Zip Code

Phone number

12) Name of primary caregiver or contact if different from client

13) Gender

Male

Female

Sub Module 2.4: Reason for Referral

1) Select reasons from list box

Sub Module 2.5: DSM Diagnosis, if known at time of referral

1) Primary Diagnosis (pull down list)

2) Secondary Diagnosis (pull down list)

3) GAF Score (pull down list)

4) Name of person/agency who diagnosed child

5) Estimated date of diagnosis

Sub Module 2.6: Other Agency Involvement

1) Name of other agencies working with child

2) Type of agency (list box)

3)

Module 3: Referral Disposition

Sub Module 3.1: Disposition

1) Select disposition for each program offered:

Program 1

a) Does child meet program criteria: yes/no

b) If yes, do you want to admit this child: yes no

1. Admit date

Program 2

a) Does child meet program criteria: yes/no

b) If yes, do you want to admit this child: yes/no

1. Admit date

Program 3

a) Does child meet criteria for this program: yes/no

b) If yes, do you want to admit this child: yes/no

1. Admit date

2) Refer out, client does not meet admission criteria at this time

Name of provider referring to (out):

Date of referral

Module 4: Intake

Sub Module 4.1: Basic demographic data:

1) Child name (1-6 may automatically show up on screen in text boxes)

2) Date of birth

3) Address

4) Child phone number

5) SSN#

6) Gender type

7) Date release of information form signed

Sub Module 4.2: Ethnicity

1) Ethnicity of child

Alaskan Native

American Indian

Asian or Pacific Islander

Black

Hispanic/Spanish origin

White

Other

2) Ethnicity of mother

3) Ethnicity of father

4) Primary language of child

List box

5) Is child fluent in English

Yes

No

Sub Module 4.3: Caregiver Information

1) Legal guardian name

Street, Apt#

City

State

Zip Code

Home phone

Work phone

1. OK to call at work: yes/no

Pager

Cell phone

E-mail address

3) Parent name, if different from guardian

Street, Apt#

City

State

Zip Code

Home phone

Work phone

1. OK to call at work: yes/no

Pager

Cell phone

E-mail address

4) Most knowledgeable caregiver, if different from parent or guardian

Relationship to child

Street, Apt#

City

State

Zip Code

Home phone

Work phone

1. OK to call at work: yes/no

Pager

Cell phone

E-mail address

Sub Module 4.4: School Information

1) School name

2) Grade

3) Primary school contact

4) Educational program type (list box)

Sub Module 4.5: Religious Information

1) Religious preference, if applicable (list box)

pull down list

Sub Module 4.6: Probation/Caseworker information

1) Case Manager names

agency name

work phone

work fax

cell phone

pager

2) Probation Officer names

court name

work phone

work fax

cell phone

Sub Module 4.7: DSM Diagnosis (pull down information from sub module 2.5 to confirm or edit)

1) Primary Diagnosis (pull down list)

2) Secondary Diagnosis (pull down list)

3) GAF Score (pull down list)

4) Name of person/agency who diagnosed child

5) Date of diagnosis

6) Names of current mental health providers

Provider name

Agency name

Work phone

Fax

Cell phone

Pager

E-mail

Sub Module 4.8: Testing Information

1) Select Tests that have been administered on client

Intellectual (IQ) Test

Results

a) Full scale score

b) Verbal score

c) Comments (TEXT BOX)

d) Estimated date

Psychological Evaluation

Results

a) Within normal limits

b) Outside of normal limit

c) Don't know

d) Comments (TEXT BOX)

e) Estimated date

Psychosexual Evaluation

Results

a) Within normal limits

b) Outside of normal limit

c) Don't know

d) Comments (TEXT BOX)

e) Estimated date

Psychosocial Evaluation Results

a) Within normal limits

b) Outside of normal limit

c) Don't know

d) Comments (TEXT BOX)

e) Estimated date

Neurological Evaluation

Results

b) Within normal limits

c) Outside of normal limit

d) Don't know

e) Comments (TEXT BOX)

f) Estimated date

Educational Evaluation

Results

a) Grade level

b) Don't know

c) Comments (TEXT BOX)

d) Estimated date

Other

Sub Module 4.9: Developmental Disabilities

physical disability

cognitive disability

psychological disability

sensory disability

speech impairments

Sub Module 4.10: Child Physical Health History

1) Childhood Illnesses

Chicken pox

Measles

Mumps

Scarlet Fever

German Measles

Other

2) Current medical conditions

Name of any current medical conditions being treated for

a) Asthma

b) Lung Disease

c) TB

d) High Blood Pressure

e) Heart Disease

f) Rheumatic Fever

g) Nervous Stomach

h) Ulcer

i) Diabetes

j) Obesity

k) Kidney Disease

l) Hernia or Rupture

m) Surgery or Operation

n) Allergies

o) Head Injury

p) Loss of Consciousness

q) Fainting

r) Seizure/Convulsion

s) Spinal Injury/Surgery

t) Physical handicaps

u) Fetal Alcohol Syndrome

v) Muscle Disease

w) Thyroid Disease

x) Arthritis/Rheumatism

y) Broken Bones

z) Medical Admission into Hospital

aa) Other

Name of Treating Physicians

Physician phone number

Physician fax

Physician e-mail

3) Current medications

Name

Dosage and frequency

Reason

Physician

Start date

4) Activity or dietary restrictions

5) EPSD&T Screening

Screening conducted Yes/No

Date of screening, if applicable

Agency location

Sub Module 4.11: Family Physical Health History

1) Has child's biological mother or father ever had any of the following conditions:

a) Asthma

b) Lung Disease

c) TB

d) High Blood Pressure

e) Heart Disease

f) Rheumatic Fever

g) Nervous Stomach

h) Ulcer

i) Diabetes

j) Obesity

k) Kidney Disease

l) Hernia or Rupture

m) Surgery or Operation

n) Allergies

o) Head Injury

p) Loss of Consciousness

q) Fainting

r) Seizure/Convulsion

s) Spinal Injury/Surgery

t) Psychiatric Diagnosis

u) Alcohol and Drug Abuse

v) Physical handicaps

w) Fetal Alcohol Syndrome

x) Muscle Disease

y) Thyroid Disease

z) Arthritis/Rheumatism

aa) Broken Bones

bb) Medical Admission into Hospital

cc) Other

If have psychiatric diagnosis, list name of diagnosis:

Sub Module 4.12: Sibling Information

1) Sibling name

2) Date of Birth

3) Gender

4) DSM diagnosis (if applicable)

5) Medical history

Click down box of medical conditions (same as 4.10)

Sub Module 4.13: Custody Status

1) State Custody

yes

no

2) If yes, then by what order

Dependent & Neglected

Delinquent

Unruly

2) Current custody setting (list box)

3) Begin date in this setting

4) End date in this setting

Sub Module 4.14: Insurance/Payor information

Sub Module 4.15: Program Funding information

Sub Module 4.16: Other Agency Involvement: (Pull from 2.6 and update here)

1) Name of other agencies working with child

2) Type of agency (list box)

3) Name of provider

4) Services provided

5) Start date

6) End date

7) Service rate

8) Service frequency

Sub Module 4.17: Community Activities

1) Type of community activities child is involved in

Full Time Employment

Part Time Employment

School

Sports

Church

Youth Clubs

Other

None

Sub Module 4.18: Living Environment Assessment

Sub Module 4.19: Family's Concerns

1) List box

2) Text box for general comments

Module 5: Mental Health Assessments

1) Series of online assessments generated and scored by the database

Module 6: Service/Treatment Planning and Clinical Records

Sub Module 6.1: Integrated Summary of Findings

1) Coordinator's impression of presenting needs (Module 1.15)

Review list of presenting needs ID'd in 1.15 and select “address”, “defer”, “refer”

2) Coordinator's impression of developmental disability (Module 3.4)

Review the list of presenting needs ID'd in 3.4 and select “address”, “defer”, “refer”

3) Coordinator's impression of child's physical health (Module 3.5.2)

Review the list of presenting needs ID'd in 3.5 and select “address”, “defer”, “refer”

4) Coordinator's impression of custody status (Module 3.7.2)

Show current custody setting ID'd in 3.7.2 and select “address”, “defer”, “refer”

5) Coordinator's impression of school involvement (Module 3.11)

Review the list of school involvement ID'd in 3.11 and select “address”, “defer”, “refer”

6) Coordinator's impression of community activities (Module 3.12)

Review the list of community activities ID'd in 3.5 and select “address”, “defer”, “refer”

7) Coordinator's impression of family's concerns (Module 3.14)

Review list of concerns ID'd in 3.14 and select “address”, “defer”, “refer”

8) Coordinator's impression of living environment (Module 4.1)

Coordinator lists living environment needs and selects “address”, “defer”, “refer”

9) Coordinator's impression of client strengths (Module 4.2)

Coordinator lists client strengths and selects “address”, “defer”, “refer”

10) Coordinator's impression of child's like and dislikes (Module 4.3)

Coordinator lists living environment needs and selects “address”, “defer”, “refer”

Sub Module 6.2: Treatment Plan

List each presenting need (form above) and disposition code with the address items first, refer items second and refer items last

A. “Items to be Addressed”

1) List services for each need (this should be a list box of all possible services)

2) List frequency of each service

3) List rate for each service (this should be a list box of rates for all services)

4) List start date for each service

5) List end date for each service

6) List goal for each service

7) List provider name for each service

8) List target completion date for each service

9) List review date for each service

*Repeat for each need that was selected as “Address”

B. List “Ancillary Services” from section 3.9

C. “Items to be Referred”

1) List services that were selected as defer

2) List name of provider referring to

3) List date of referral

4) List status of referral

D. “Items to be Deferred”

1) List services that were deferred

2) List date of deferral

Sub Module 6.3: Clinical Notes and Client Records

A. Client Records

1) Client Master Index (“face sheet”)

2) Treatment Plan/Service Plan

3) Medication Orders, Prescriptions, Med Monitoring

4) Treatment Plan Review

5) Continued Stay Criteria

6) Discharge Summary/Aftercare Plan

7) Discharge Criteria

8) Clinical Progress Note

9) Group Notes

10) Weekly Summary Notes

11) Consultation Notes

12) Lab Orders and Reports

13) Personnel Care Logs

14) Contact Logs

15) Physician General Orders

16) Special Therapeutic Intervention Notes

B. Performance Improvement

1) Clinical Record Review/Checklist

2) Patient Satisfaction Survey

3) Monthly Program Performance Data Entry Form

4) Quarterly Program Performance Analysis Score Sheet

C. Environment of Care

1) Safety Checklist

2) Incident/Accident/Injury Report

3) Fire Drill

4) Disaster Drill

5) Infection Control incident report

Module 7: Evaluation Reports

Sub Module 7.1: Clinical Management reports (population management and clinical outcome measurement)

Sub Module 7.2: Financial Management reports (includes billing)

Sub Module 7.3: Quality Management reports

Sub Module 7.4: Referral Development reports

Sub Module 7.5: Activity and Productivity Management reports

Sub Module 7.6: Human Resource Management Reports

Sub Module 7.7: Contract Compliance Reports

Sub Module 7.8: Electronic Clinical Records Audit Reports

Sub Module 7.9: Safety and Environment of Care Reports

Sub Module 7.10: Medication Management Reports

Module 8: Client and Staff Activity Log

a. Report activities and record time

Module 9: Human Resources

Sub Module 9.1: Staff Information

1) Name

2) Date of birth

3) Race

4) Gender

5) SS#

6) Address

7) Phone#

8) Emergency contact 1, 2

9) Date of hire

10) Date of re-hire

11) Position/title

12) Exempt/non-exempt status

13) Hourly wage; Annual salary

14) Credentials

15) Educational degree/s

16) Insurance enrollment status

17) Date of TB screen; Date of Hep B vaccination

Sub Module 9.2: Staff Training Log

1) Name

2) Position/Title

3) Credentials

4) Training topic/course name

5) Trainer name

6) CME Credit amount

7) CEU Credit amount

8) Licensure Credit amount

9) Certification Credit amount

10) Date of Training

11) Length of training

Sub Module 9.3: Performance Status

1) Name

2) Date of hire

3) Position/title

4) Type of review

5) Review date

6) Review results/scores/ratings

7) Reviewer comments

8) Reviewer name

9) Reviewer position/title

10) Merit/salary adjustment date

Sub Module 9.4: Termination/Resignation

1) Name

2) Effective date of termination/resignation

3) Reason for termination/resignation (list box)

4) Property returned yes/no

Module 10: Accounts Receivable

1) Currently being designed, functionality may include:

a. Customized billing forms

b. Electronic claims processing

c. Insurance claim forms HCFA-1500, ub-0/92, etc.

d. Capitated payments

e. Fee for service billing

f. Fee for case billing

g. Per diem billing

h. Self pay billing

i. Client copays

j. Purchase of services billing

k. Sliding scale fee adjustments and calculations

l. Spend-down billing reports for Medicaid

m. Third party reimbursement calculations

n. Batching of activity and cash entry

An alternative list of modules may be provided as follows:

1. Referral and Intake Application

Pre-Admission Modules

Referral Information Modules

Intake and Admission Modules

Referral Reporting Modules

2. Clinician Care Center Applications

Provider alerts

Provider caseload

Provider activity log

Provider schedule

Provider Reports

Memos

Provider contacts

Provider e-mail

On-line links to web resources

3. Client Case Record

General Information

Basic Information

Home Information

Education History

Client Presenting Problems

Family Presenting Problems

Case Assignment History

Family and Significant Others

Special Care Requirements

Special Circumstances

Standard Tests/Clinical Judgments

Visitation Restrictions

Placement History

Physical Status

Significant Medical Conditions

Handicaps

Immunizations

Medication Display

Special Diet

Physical Description

Diagnostic Information

Status Profile Assessment

Environmental Profile Assessment

Process Therapy Diagnostic Assessment History

DSM (Diagnostic Statistical Manual) Diagnoses

Examination History

Medication History

GAF (Global Assessment Factor) Score History

Funding Information

Program History

Funding History

Funding Authorization History

Special Funding Messages

Florida State Reporting

ICD-9 Score Information

Enrollment History

Outcome Assessment History

Tennessee State Reporting

TPG Funding Certification History

Florida State Reporting

ICD-9 Entry/Update

Enrollments

FL State Outcome Measurements

Foster placement information/history

4. Monitor Call Application

Monitor Call List

Home Call List

Monitor Call Assessments

Alternate Monitor Call List

Client Specific Monitor Reporting

Monitor Call Profile

Daily, Weekly and Monthly Monitor Call Reports

Monitor Call Trend Line Graphical Reports

Monitor Call E-MAIL and Fax Reports and Clinician Alerts

A-3. Administrative Management System Applications

Professional (Staff) Information

Professional History

Foster & Relative Home Information

Other Resource Information

Funding/Payor/Contract Information

State/County Department Information

Management Reporting Entry

Environment of Care Reporting Entry

CQI (PPA) Reporting Entry

Satisfaction Survey Reporting Entry

A further representation of the modules may be as follows:

1. Referral and Intake Modules

Referral waiting list

Open caseload scheduling

Master daily schedule summary for all employees by location

Client referral demographic information

Address and contact information

Referral source information

Presenting problem narrative

Family member data

Client designation

Requested service information

Client funding information (program, funding, eligibility, verification and authorization)

Screening assessments and referral disposition designation

Admission processing

Direct caseload assignment

Client “face sheet” summary data

Referral and Intake Reports

2. Clinician's Care Center Modules

Provider alerts

Provider caseload

Provider activity log

Provider schedule

Reports

Memos

Provider contacts

Provider e-mail

On-line links to web resources

3. Fully Integrated Client Record (IBER)

A. Provider Schedule

B. Client General Information

Client “Face Sheet” Summary

Client demographics

Family members

Staff relationships

Program/Funding information

Funding Messages

Education

Special care requirements

Special circumstances

Test/Clinical judgment

Visitation restrictions

Placement history

C. Medical

Medications

Treatment history

Allergies

Physician orders

Medication administration

Medication inventory

Medical consults

Significant medical conditions

Handicaps

Immunizations

Special dietary needs

D. Assessments

Referral screening

Bio-Psychosocial Assessment

Substance Abuse Screening

Child and Adolescent Assessment

Psychiatric Evaluation and History

Medical Assessment

Mental Status Exam

Integrated Summary

Nursing Assessment

Medical Assessment

Pain Assessment

Nutritional Assessment

AIMS Assessment

Neurological Assessment

E. Client Record

Client Presenting problems

Family Presenting problems

Index of needs

Preliminary care plan

Care plan review

Plan of care

Progress notes

PTDA scale scores

DSM Diagnosis

GAF scores

Discharge/Transfer/Death Summary

F. Florida Reporting

ICD-9 Entry/Update

Enrollments

Outcomes

G. Tennessee Reporting

TPG Certifications

H. Foster Care Records

Foster placement information/history

J. Clinical and Client Reports

C-3. Administrative/Financial Management Applications

1. Billing/AR/Reimbursement Module

Failed activity maintenance

Billing search

Billing approval

Non-client activity entry

Payment Entry

Payment maintenance

Payment display

On account payment application

Payment batch entry

Single client payment

Pending item approval

Item maintenance

Overnight batch

Activity to billing

Aging category setup

Online aging report

Payer transactions

Billing Reports

2. Human Resource Module

Employee general information

New hire checklists (full time and part time employees)

Employee contact and emergency contact information

Employment position and salary history

Payroll status history

Employee benefits history

Credential verification information

Insurance provider credential status

Employee training information

Employee performance review information

Termination summaries

Insurance provider information

Human Resource/Staff Reports

3. Quality Improvement Applications

Monthly management reporting

Environment of Care reporting

Program performance analysis system

Customer satisfaction assessments

4. On-line Monitor Call Center

Call log system

Online monitor call assessment

Monitor Call Reports

5. Administrative Menu

Foster home

Other resources

Department

Although the invention has been defined using the appended claims, these claims are exemplary in that the invention may be intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations. For instance, in various embodiments, a certain order to the data has been shown. However, any reordering of the data is encompassed by the present invention.

We claim:

1. A system for storing information comprising:
a network of computers including the Internet;
a first web-based client at a first location connected to said network, said first client comprising:
an input for receiving patient information; and
an output for transmitting said patient information over said network;
a web server at a second location, said web server being connected to said network and receiving said patient information;
a database server storing said patient information and being directly connected to said web server.

2. The system according to claim 1, wherein in response to a request from said client, said database server provides at least some of said patient information to said web server for forwarding to said client.

3. The system according to claim 2, wherein the amount of said patient information is determined by at least one of a level of permissions granted to said client and the amount of said patient information currently stored in said database server.

4. The system according to claim 1, further comprising:
a second client at a third location, said second client connected to said network,
wherein said second client is able to obtain and/or update at least some of said patient information.

5. The system according to claim 4, wherein said first client provides a permission for said second client to obtain and/or update at least some of said patient information.

6. The system according to claim 5, wherein said permission is a referral regarding said second client.

7. The system according to claim 5, further comprising:
a third client, said third client having been permitted to obtain said patient information,
wherein the amount of patient information obtainable by said third client is different from the amount of information obtainable by said second client.

8. A web-based client connected to a network of computers including the Internet, said network connected to a web server, said web server connected directly to a database server, said web based client comprising:
an input for receiving patient information; and,
an output for transmitting said patient information to database across said network,
wherein said database server stores said patient information and provides access to said patient information to at least another client.

9. A method of processing patient information on a web-based client comprising the steps of:
designating a patient;
designating a type of information to be associated with said patient;
transmitting said designations over the Internet to a remote web server which is directly connected to a database server;
receiving a form for receiving said type of information;
populating said form;
transmitting at least the information populated on said form to said remote web server, which forwards the information to said database server.

10. The method according to claim 9, further comprising the steps of:
transmitting a permission regarding said patient and a remote client to said database server,
wherein said remote client may obtain at least some of said information to be associated with said patient.

11. The method according to claim 9, wherein said form relates to a first module of information to be stored on said remote database, and wherein said method further comprises:
receiving a second form from said remote database server, said second form relates to a second module of information.

12. A system for storing information from a web-based client at a first location that receives patient information and outputs the information to a network including the Internet, said system comprising:
a web server at a second location, said web server being connected to said network and receiving said patient information;
a database server storing said patient information, said database server being directly connected to said web server.

13. The system according to claim 12, wherein in response to a request from said client, said database server provides at least some of said patient information to said web server for forwarding to said client.

14. The system according to claim 13, wherein the amount of said patient information is determined by at least one of a level of permissions granted to said client and the amount of said patient information currently stored in said database server.

15. The system according to claim 12, wherein said database server receives a permission for a second client at a third location to obtain and/or update at least some of said patient information.

16. The system according to claim 15, wherein said permission is a referral regarding said second client.
